(19) United States
(12) Patent Application Publication
(10) Pub. No.: US 2010/0122254 A1
(43) Pub. Date: May 13, 2010

(54) BATCH AND APPLICATION SCHEDULER INTERFACE LAYER IN A MULTIPROCESSOR COMPUTING ENVIRONMENT

(75) Inventor: Michael Karo, Seattle, WA (US)

Correspondence Address: SCHWEGMAN, LUNDBERG & WOESSNER, P.A., P.O. BOX 2938, MINNEAPOLIS, MN, 55402, US

(73) Assignee: Cray Inc., seattle, WA (US)

(21) Appl. No.: 12/268,916

(22) Filed: Nov. 11, 2008

(51) Int. Cl. G06F 9/46

(52) U.S. Cl. 718/101

(57) ABSTRACT

A multiprocessor computer system batch system interface between an application level placement scheduler and one or more batch systems comprises a predefined protocol operable to convey processing node resource request and availability data between the application level placement scheduler and the one or more batch systems.

### FEDERALLY SPONSORED RESEARCH OR DEVELOPMENT

The U.S. Government has a paid-up license in this invention and the right in limited circumstances to require the patent owner to license others on reasonable terms as provided for by the terms of Contract No. MDA904-02-3-0052, awarded by the Maryland Procurement Office.

### FIELD OF THE INVENTION

The invention relates generally to scheduling resources in a computer system, and more specifically in one embodiment to a batch scheduler interface layer in a multiprocessing computer environment.

### LIMITED COPYRIGHT WAIVER

A portion of the disclosure of this patent document contains material to which the claim of copyright protection is made. The copyright owner has no objection to the facsimile reproduction by any person of the patent document or the patent disclosure, as it appears in the U.S. Patent and Trademark Office file or records, but reserves all other rights whatsoever.

### BACKGROUND

Most general purpose computer systems are built around a general-purpose processor, which is typically an integrated circuit operable to perform a wide variety of operations useful for executing a wide variety of software. The processor is able to perform a fixed set of instructions, which collectively are known as the instruction set for the processor. A typical instruction set includes a variety of types of instructions, including arithmetic, logic, and data instructions.

In more sophisticated computer systems, multiple processors are used, and one or more processors runs software that is operable to assign tasks to other processors or to split up a task so that it can be worked on by multiple processors at the same time. In such systems, the data being worked on is typically stored in memory that is either centralized, or is split up among the different processors working on a task.

Instructions from the instruction set of the computer's processor or processor that are chosen to perform a certain task form a software program that can be executed on the computer system. Typically, the software program is first written in a high-level language such as “C” that is easier for a programmer to understand than the processor's instruction set, and a program called a compiler converts the high-level language program code to processor-specific instructions.

In multiprocessor systems, the programmer or the compiler will usually look for tasks that can be performed in parallel, such as calculations where the data used to perform a first calculation are not dependent on the results of certain other calculations such that the first calculation and other calculations can be performed at the same time. The calculations performed at the same time are said to be performed in parallel, and can result in significantly faster execution of the program. Although some programs such as web browsers and word processors don't consume a high percentage of even a single processor's resources and don't have many operations that can be performed in parallel, other operations such as scientific simulation can often run hundreds or thousands of times faster in computers with thousands of parallel processing nodes available.

The program runs on multiple processors by passing messages between the processors, such as to share the results of calculations, to share data stored in memory, and to configure or report error conditions within the multiprocessor system. In more sophisticated multiprocessor systems, a large number of processors and other resources can be split up or divided to run different programs or even different operating systems, providing what are effectively several different computer systems made up from a single multiprocessor computer system.

Configuring and managing the resources used for various instances of applications and operating systems in such an environment is therefore desirable.

### SUMMARY

Some embodiments of the invention comprise a multiprocessor computer system batch system interface between an application level placement scheduler and one or more batch systems, the interface comprising a predefined protocol operable to convey processing node resource request and availability data between the application level placement scheduler and the one or more batch systems.

### BRIEF DESCRIPTION OF THE FIGURES

FIG. 1 shows an example application level placement scheduler block diagram, consistent with an example embodiment of the invention.

FIG. 2 shows an example multiprocessor system comprising an application level placement scheduler, a batch system, and a reservation system, consistent with an example embodiment of the invention.

### DETAILED DESCRIPTION

In the following detailed description of example embodiments of the invention, reference is made to specific examples by way of drawings and illustrations. These examples are described in sufficient detail to enable those skilled in the art to practice the invention, and serve to illustrate how the invention may be applied to various purposes or applications. Other embodiments of the invention exist and are within the scope of the invention, and logical, mechanical, electrical, and other changes may be made without departing from the scope or subject of the present invention. Features or limitations of various embodiments of the invention described herein, however essential to the example embodiments in which they are incorporated, do not limit the invention as a whole, and any reference to the invention, its elements, operation, and application do not limit the invention as a whole but serve only to define these example embodiments. The following detailed description does not, therefore, limit the scope of the invention, which is defined only by the appended claims.

In multiprocessor computer environments in which multiple applications, multiple operating systems, or multiple virtual machines are running, scheduling and managing computing resources well can significantly affect the usefulness and efficiency of the computer system as a whole. Many such systems will be used or configured differently by different customers, such that one customer uses an entire computer system as a single high-powered supercomputer, while another customer allows users to run separate instances of different operating systems, each executing different software on different schedules.

One example embodiment of the invention seeks to provide a computer system operator the ability to manage such a computer system using an Application Layer Placement Scheduler (ALPS). ALPS is designed to work with different batch or job systems for different customers, and operates at the system service level, between applications and the operating system. The ALPS scheduler sets various resource policies, such as limiting resources available to a specific application, and in further embodiments provides other functions such as load balancing and masking architectural dependencies from the load balancing process.

### Application Level Placement Scheduler

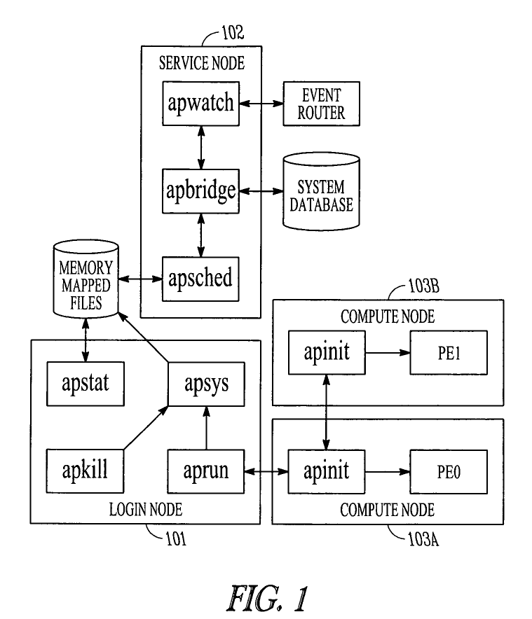

The ALPS architecture is divided into several components, as illustrated in FIG. 1. The modular design presented here facilitates code reuse, such as among different platforms or revisions, and reduces maintenance costs. Here, a login node 101 is coupled via a processor or node interconnect network to a service node 102 and one or more compute nodes 103. In alternate embodiments, the different node processes can execute on the same node, or can each be distributed among multiple nodes.

Referring to the login node 101, the aprun client represents the primary interface between a computer user and an application being executed. To execute a program, the user specifies various command line arguments that identify the executable application code and convey resource requirements for the application. The aprun client also is responsible for managing standard input, output, and error streams, and for forwarding user environment information and other signals.

The aprun client then contacts the apsys daemon also shown as a part of the login node 101, which provides access to the application scheduler module apsched in the service node 102. The apsys daemon further communicates pending application status information to the apstat client in login node 101 via shared memory-mapped files as shown in FIG. 1. Incoming requests from ALPS client programs are processed in apsys, which maintains a connection to the aprun client.

Once aprun has contacted apsys, aprun sends the user-provided information regarding application execution to apsys, which forwards the request to the apsched daemon to obtain a resource placement that is resources the user specified as required to execute the application. If a suitable resource scheduling or allocation is not found, this process is repeated until adequate resources are found. The apsched daemon then generates a placement list and schedules a reservation, and relays the information to the aprun client.

The apsched daemon shown as part of the service node at 102 of FIG. 1 manages memory and processor resources associated with applications running on various computer nodes. Apsched in further embodiments will attempt to optimize application placement to the extent that it is able to enhance resource utilization and performance. Because different nodes may have different resources available, managing node placement is not a trivial task in many environments. Management of scarce resources such as memory management is also important to ensure efficient operation of the executing applications, and to ensure that memory is not underutilized or oversubscribed.

Once apsched has reserved a set of node resources for an application, apsched ensures the resources cannot be committed to another application. The aprun client contacts the apinit daemon running on the first compute node 103A and forks an application shepherd process to manage the process or processes that will execute on the processing node. The aprun client also transmits the placement list for the application and the executable binary application data to the shepherd process. The variety of process nodes assigned to an application form an application control tree of shepherd processes on each node that are operable to communicate with the aprun client, which is then used to initialize the program execution.

The application initialization process begins once the control tree has been established and the placement list communicated to each of the processing nodes' shepherd processes. The user's environment is recreated on each processing node, and other functions such as memory allocation are performed. Control is then passed to the executing application.

During application execution, the shepherd processes on the various nodes propagate various signals between the executing applications and the aprun client, which manages standard input and output, and standard error streams. The system also ensures that when an application exits, whether normally or due to error, the resources used by the application are surrendered back to the application level placement scheduler. After memory is released, stray processes are closed, and other such cleanup functions are completed, the aprun client executing on the login node 101 that is managing the specific application exits.

The aprun client therefore represents the primary interface between the user and an executing application. Its primary function is to submit applications to the ALPS system for placement and execution, but it also parses command line arguments, forwards the user environment to processing nodes, and manages standard I/O and error streams during program execution.

The apstat client relays status information from the ALPS system to the user, including data describing resource availability, reserved resources, and running applications. In one embodiment, apstat uses memory mapped files that the other daemons maintain to acquire data needed to generate user reports including such data. This reduces the demands on the ALPS daemons during status reporting, enabling them to more effectively service applications.

The apkill client is responsible for delivering signals to applications, normally including a signal type, application ID, and any associated command line arguments. The client contacts the local apsys daemon, which generates an apsys agent to manage a transaction. The agent locates the login node on which the aprun client for a target application resides by using the memory mapped files, and the apsys agent delivers the message if the aprun client is on the local node or contacts the apsys agent on the proper node if the application's aprun client is on another node.

The apbasil client represents the interface between ALPS and the batch system, and implements a batch and application scheduler interface layer, or BASIL. BASIL is implemented as a standard protocol, such as an XML protocol interface layer in one embodiment, acting as a bridge between ALPS and third-party batch schedulers or other resource managers.

A variety of daemons execute in the example ALPS environment presented here, including an apbridge, apwatch, apsys, apinit, and apsched daemon. The apbridge daemon provides a bridge between the architecture-independent ALPS system and the architecture-dependent configuration of the underlying multiprocessor computer system. More specifically, it queries a system database to collect data on the hardware configuration and topology, and supplies the data in a standard format to the apsched daemon for scheduling.

The apbridge daemon interfaces with the apwatch daemon, which registers with a machine-specific mechanism to receive system events and forward them in an architecture-neutral format to apbridge for further processing, where the system state events can be forwarded to apsched and used for application scheduling and resource management.

The apsys daemon provides ALPS client programs access to apsched, and delivers pending application status information to apstat by logging the data to a shared file. There is one apsys daemon per login node, and the apsys daemon forks an apsys agent child to process incoming requests from ALPS client programs. The apsys agent child retains a connection to aprun for the life of the aprun program, and is responsible for processing apkill signal requests, resource reservation messages from apbasil, and notifying apsched about resource reservations to be freed.

The apinit daemon is started on each compute node as part of the boot procedure, and receives connections from the aprun client including information needed to launch and manage a new application. The apinit master daemon constructs a control structure using this information to maintain knowledge regarding the application running on the local node, and forks an apshepherd process dedicated to managing the specific application on the local node. Apshepherd manages the connection to aprun, while the apinit master daemon continues to listen for new messages and monitors the one or more apshepherd processes on the local compute node.

Apshepherd provides standard I/O and error connectivity to the remote aprun client, and initiates the application after performing whatever architecture-specific setup functions are needed to prepare the local node environment for program execution. Apshepherd nodes also receive and forward application launch messages and other such control messages, using various radix specifications as needed to scale to a large number of nodes.

The apsched daemon manages memory and processor resources associated with particular applications running on the various compute nodes in a multiprocessor computer system running ALPS. In some further architectures, nonuniform or shared memory and interconnect state are also managed by the apsched daemon, along with other resources such as nonvolatile storage. Although apsched does not enforce policy, it is responsible for ensuring the accuracy of application placement and resource allocation, such that a resource list generated as a result of a reservation placement request includes specific resources that are assuredly reserved for the application.

The apsched daemon therefore is able to mange problems such as memory oversubscription, interactive jobs that take over resources from temporarily idling batch jobs, and other such problems that are not uncommon in multiprocessor computer systems.

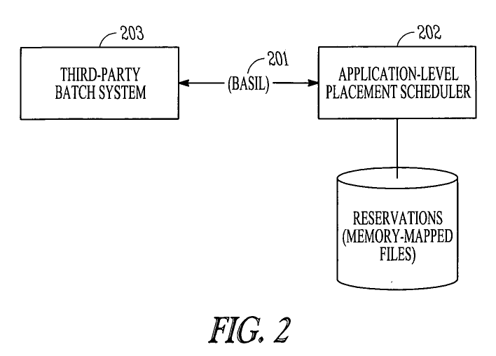

The reservation and batch and application scheduler interface layer to third-party patch systems are shown in FIG. 2, and are described in greater detail below.

### Batch System Integration

Third-party batch systems can be used in some further examples using a Batch and Application Scheduler Interface Layer 201, or BASIL, to act as a gateway between the Application Level Placement Scheduler 202 and the batch systems 203. BASIL is implemented in one embodiment as an interface protocol that includes the primary functions of inventory, reservation creation, and reservation cancellation. When a user submits a job to a batch system, the batch scheduler determines whether sufficient resources are available to run the job by obtaining a current picture of the available and assigned resources in the computer system. BASIL provides such data through its XML-PRC interface, providing information in a format that can be easily parsed by third-party batch systems.

The batch scheduler can use the XML data obtained from BASIL to schedule one or more batch jobs for execution. Once a batch job has been scheduled, the batch system initialized the job on one or more login nodes of the multiprocessor computer system, such as node 101 of FIG. 1. During initialization, the batch system creates an ALPS reservation for the job to ensure that resources remain available through the lifetime of the executing application. Although there may be resources that are not utilized during some periods of application execution, the reservation system of ALPS prevents ALPS from creating conflicting resource assignments.

The apbasil client in the ALPS system therefore acts as an interface between various batch systems, including third-party batch systems, and the lower level system resource manager within the example system presented here. During execution of a batch job, there may be several calls to aprun to launch applications using the reserved set of resources, such that ALPS recognizes that the application launch occurs via the batch scheduler job and assigns resources reserved for the job to be used.

Upon completion of a batch job, the batch system makes a final BASIL request to cancel the reservation for the job. The reserved resources are then freed, and are available for reassignment to other jobs.

### Reservations

BASIL and ALPS therefore operate using a system of reservations, providing support for both batch and interactive application execution in a multiprocessor computer environment. Resource reservation ensures that batch applications are able to reserve the resources needed to schedule and execute the required jobs without interactive applications usurping resources from the batch jobs during periods when the bath application is not actively using all its needed resources. Reservations also ensure that resources that aren't being used when batch job is scheduled will still be available when a job executes, rather than simply observing what resources are being utilized and what resources are free at the time the batch job is scheduled.

The state of reservations in this example is maintained by apsys to provide a central point for reservation coordination. The BASIL interface is used to service reservation traffic from clients, such as aprun, and scheduler modules, such as apsched, to eliminate the need for proprietary reservation coding to interact with the reservation system.

A hierarchy of data structures are used to manage reservation information in one example, including processor type, memory requirement, placement geometry, reservation dependencies, and other attributes. Reservations can also exist in a number of different states, including filed, available, confirmed, and claimed, as well as several substates. Filed reservations are created by the aprun client posting an event to apsyst to register a reservation, and apsys replies with a reservation ID confirming that the reservation is filed. The aprun client then waits for the reservation to become available, such as by receiving notice that it has been scheduled at a time when sufficient resources will be free. In a batch environment, the batch system waits for the reservation to become available, and can post an event to apsys in place of the aprun client.

Once a reservation is filed and all reserved resources are available, the reservation becomes available. An event is posted to allow batch schedulers to confirm the reservation, such as to select one of multiple reservations made to execute a particular job. Interactive jobs are automatically confirmed in some embodiments, or are confirmed by the batch scheduler if outside jobs not submitted through the batch system do not conflict with other reservations.

A reservation becomes confirmed for interactive jobs when apsys sends an event to aprun indicating that it should claim the assigned resources. For batch jobs, the batch system scheduler receives an event indicating that a reservation has been confirmed. The batch system scheduler then signals the batch server to start the job associated with the confirmed reservation, and the reservation remains in a confirmed state for a predetermined amount of time, such as two minutes.

For interactive jobs, the confirmed reservation is claimed by aprun posting an event to claim claim the reservation. ALPS then confirms that the identity of the aprun caller matches that of the reservation to prevent a user from claiming another's reservation, and apsys places the reservation in a confirmed state and sends a response to aprun that includes a complete description of the claimed reserved resources. The aprun process then signals the apsys agent to begin the application start procedure. For batch jobs, the batch server sends a message to a local launch daemon, which posts an event to claim the reservation. The event instructs apsys to place the reservation in a claimed state, and aprun is invoked via the batch job script.

The reservation systems of the example embodiments described here illustrate how a reservation system can be used with a placement scheduler to guarantee that resources for a job will be available for the lifetime of a job, preventing conflicting resource assignments from applications that are launched via batch jobs and applications that are interactively from outside the batch system. It also provides the batch system with a mechanism to accurately determine the state and availability of processing nodes and other resources, and applications within the multiprocessor computer system.

### SUMMARY

The system of application level placement scheduling, batch scheduling, and reservations presented here illustrate how a multiprocessor computer system can manage the availability of resources in the multiprocessor computer system while accommodating third-party batch systems, combinations of interactive and batch jobs, and other challenges. The application level placement scheduler (ALPS) is able to manage availability of resources and to map requests to resources such as processing nodes, and is able to distribute, monitor, synchronize, applications among processing nodes and reclaim processing node resources upon application exit.

The batch and application scheduling interface layer (BASIL) provides an interface between the placement system and batch scheduling systems, including third-party batch scheduling systems. It includes use of a predefined protocol such as user-friendly XML parameters used to allow the batch system to perform functions such as requesting processing node resource availability data, and provide for coordination of resource assignments between the batch system and placement scheduler, enabling management of batch jobs containing applications.

The reservation system described allows coordination of resource reservation within the placement scheduler, and between the placement scheduler and the batch system. It also guarantees that resources will be available for applications launched from batch jobs throughout their execution lifetime in environments with interactive applications being launched, and accurately conveys the state and availability of processing nodes and applications.

Although specific embodiments have been illustrated and described herein, it will be appreciated by those of ordinary skill in the art that any arrangement which is calculated to achieve the same purpose may be substituted for the specific embodiments shown. This application is intended to cover any adaptations or variations of the example embodiments of the invention described herein. It is intended that this invention be limited only by the claims, and the full scope of equivalents thereof.

1. A multiprocessor computer system batch system interface, comprising:
an interface between an application level placement scheduler and one or more batch systems, the interface comprising a predefined protocol operable to convey processing node resource request and availability data between the application level placement scheduler and the one or more batch systems.

2. The multiprocessor computer system batch system interface of claim 1, wherein the interface comprises one or more extensible markup language (XML) elements.

3. The multiprocessor computer system batch system interface of claim 1, wherein the predefined protocol is embodied in a protocol parser operable to interpret elements in the predefined protocol.

4. The multiprocessor computer system batch system interface of claim 1, wherein the one or more batch systems comprise third-party batch systems.

5. The multiprocessor computer system batch system interface of claim 1, wherein the batch system interface is operable to convey information comprising one or more of resource inventory, reservation creation, and reservation cancellation information.

6. The multiprocessor computer system batch system interface of claim 1, wherein the batch system interface is operable to initialize a job on one or more login nodes of the multiprocessor computer system.

7. The multiprocessor computer system batch system interface of claim 1, wherein initializing a job on one or more login nodes comprises creating an ALPS reservation for the job to ensure that resources remain available through the lifetime of the executing application.

8. The multiprocessor computer system batch system interface of claim 1, wherein the batch system comprises a client operating in an application level placement scheduler.

9. A method of communicating between an application level placement scheduler and one or more batch systems in a multiprocessor computer system, the method comprising exchanging data using an interface comprising a predefined protocol operable to convey processing node resource request and availability data between the application level placement scheduler and the one or more batch systems.

10. The method of communicating between an application level placement scheduler and one or more batch systems in a multiprocessor computer system of claim 1, wherein the interface comprises one or more extensible markup language (XML) elements.

11. The method of communicating between an application level placement scheduler and one or more batch systems in a multiprocessor computer system of claim 1, wherein the predefined protocol is embodied in a protocol parser operable to interpret elements in the predefined protocol.

12. The method of communicating between an application level placement scheduler and one or more batch systems in a multiprocessor computer system of claim 1, wherein the one or more batch systems comprise third-party batch systems.

13. The method of communicating between an application level placement scheduler and one or more batch systems in a multiprocessor computer system of claim 1, wherein the batch system interface is operable to convey information comprising one or more of resource inventory, reservation creation, and reservation cancellation information.

14. The method of communicating between an application level placement scheduler and one or more batch systems in a multiprocessor computer system of claim 1, wherein the batch system interface is operable to initialize a job on one or more login nodes of the multiprocessor computer system.

15. The method of communicating between an application level placement scheduler and one or more batch systems in a multiprocessor computer system of claim 1, wherein initializing a job on one or more login nodes comprises creating an ALPS reservation for the job to ensure that resources remain available through the lifetime of the executing application.

16. The method of communicating between an application level placement scheduler and one or more batch systems in a multiprocessor computer system of claim 1, wherein the batch system comprises a client operating in an application level placement scheduler.

17. A machine-readable medium with instructions stored thereon, the instructions when executed operable to cause a computerized system to exchange data using an interface comprising a predefined protocol operable to convey processing node resource request and availability data between an application level placement scheduler and one or more batch systems in a multiprocessor computer system.

18. The machine-readable medium of claim 1, wherein the predefined protocol is embodied in a protocol parser operable to interpret elements in the predefined protocol.

19. The machine-readable medium of claim 1, wherein the batch system interface is operable to convey information comprising one or more of resource inventory, reservation creation, and reservation cancellation information.

20. The machine-readable medium claim 1, wherein the batch system interface is operable to initialize a job on one or more login nodes of the multiprocessor computer system.

21. The machine-readable medium of claim 1, wherein initializing a job on one or more login nodes comprises creating an ALPS reservation for the job to ensure that resources remain available through the lifetime of the executing application.

22. The machine-readable medium of claim 1, wherein the batch system comprises a client operating in an application level placement scheduler.
